(19) United States
(12) Patent Application Publication
(10) Pub. No.: US 2005/0060975 A1
(43) Pub. Date: Mar. 24, 2005

(54) Remotely controlled mowing device

(76) Inventor: Dean L. McClymonds, Beaver Falls, PA (US)

Correspondence Address: JOHN W JORDAN IV;GACA MATIS BAUM & RIZZA, FOUR GATEWAY CENTER, 444 LIBERTY AVENUE, SUITE 300, PITTSBURGH, PA, 15222, US

(21) Appl. No.: 10/664,692

(22) Filed: Sep. 19, 2003

(51) Int. Cl. A01D 69/00

(52) U.S. Cl. 56/10.2 A

(57) ABSTRACT

A vegetation cutting blade is rotatably attached to a deck which is vertically adjustably mounted on a frame which is supported by a pair of ground wheels on each side. Each pair of wheels is driving independent of the other by a hydraulic motor mounted on the frame which is, in turn, driven by a hydraulic pump mounted on the deck. The cutting blade and the pumps are driven by a gasoline engine mounted on the deck. Radio remote controls separately control the engine, the pumps and a clutch to disengage the cutting blade. A retractable segment of the deck can be raised by remote control to facilitate the cutting of heavy brush and small trees.

### BACKGROUND OF THE INVENTION

This invention relates to remotely controlled mowing devices and, more particularly, to radio controlled devices suitable to the mowing of steep slopes.

It is well known to provide mowing devices with remote controls for the safety or convenience of the operator. Most such devices, for example, those described in U.S. Pat. No. 5,351,778, U.S. Pat. No. 4,964,265, U.S. Pat. No. 4,318,266, and U.S. Pat. No. 3,800,902, have utilized remote controls on relatively small, lightweight, lawn mowers that would not be significantly damaged if they were to turn over. Those devices have not been designed to minimize the risk of turnover on steep slopes. Devices for cutting vegetation along roads, railway rights-of-way and the like, have been larger and have included provision for operation by a driver mounted on the device. While some such devices, like that described in U.S. Pat. No. 5,711,129, have been designed to minimize the risk of turnover, they have a relatively high center of gravity and are subject to damage if they do turn over on the steep slope.

### SUMMARY OF THE INVENTION

In the present invention a frame is mounted on four ground wheels and a deck is vertically adjustably mounted thereon. The deck acts as a safety guard for a vegetation cutting blade and also provides a surface for the mounting of remotely controlled means for driving the ground wheels and the vegetation cutting blade. The vegetation cutting blade is driven by an internal combustion engine, preferably a two cycle gasoline engine, which is connected to the vegetation cutting blade through a remotely controlled clutch. The two cycle gasoline engine also drives two hydraulic pumps, each of which is connected to a hydraulic motor which is, in turn connected to a pair of the ground wheels. Control of the speed and direction of rotation of the hydraulic pumps, and hence of the ground wheels, is provided by remote control of the hydraulic pumps. The two hydraulic pumps are remotely controllable independently of each other so that the speed and direction of rotation of the ground wheels on the right side of the mowing device and the speed and direction of rotation of the ground wheels on the left side of the mowing device can be controlled independently of each other. The gasoline tank for the two cycle gasoline engine and the oil reservoir of the two hydraulic pumps are provided with spill proof caps. Rollover bars are also attached to the deck to protect the aforedescribed means for driving the ground wheels and vegetation cutting blade if the mower rolls over on a steep slope. The leading edge of the deck is hinged and can be raised by remote control to facilitate the cutting of heavy brush and small trees.

The use of a two cycle gasoline engine permits the mower to operate on steep slopes without being deprived of oil, as would occur if a four cycle engine were employed. The mounting of the rollover bars and all of the drive means except the hydraulic motors on the vertically adjustable deck maximizes the extent to which the center of gravity of the mower can be vertically adjusted to minimize the risk that the mower will roll over on a steep slope. The remotely controlled clutch between the engine and vegetation cutting blade allows the mower to be moved under remote control while the vegetation cutting blade is disengaged, thus enhancing the safety of operation. The ability to remotely control the speed and direction of rotation of the ground wheels on either side of the mowing device independent of the speed and direction of rotation of the ground wheels on the other side permits the operator, not only to cause the mowing device to move forward and backward and to turn, but also to pivot about any of the number of vertical axis intersecting the body of the mowing device, thereby enhancing its maneuverability and suitability for operation in confined or obstructed areas.

### BRIEF DESCRIPTION OF THE DRAWINGS

FIG. 1 is a perspective view of a remotely controlled mowing device according to the present invention.

FIG. 2 is a perspective view of the frame of the mowing device of FIG. 1.

FIG. 3 is a perspective view of the deck of the mowing device of FIG. 1.

FIG. 4 is a plan view of a lifting screw utilized with the mowing device of FIG. 1.

FIG. 5 is a side elevation view of a lifting bracket utilized with the mowing device of FIG. 1.

FIG. 6 is a front elevation view of the lifting bracket of FIG. 5.

FIG. 7 is a plan view of lifting bracket of FIG. 5.

FIG. 8 is a perspective view of a radio remote control transmitter utilized with the mowing device of FIG. 1.

### DETAILED DESCRIPTION OF THE PREFERRED EMBODIMENT

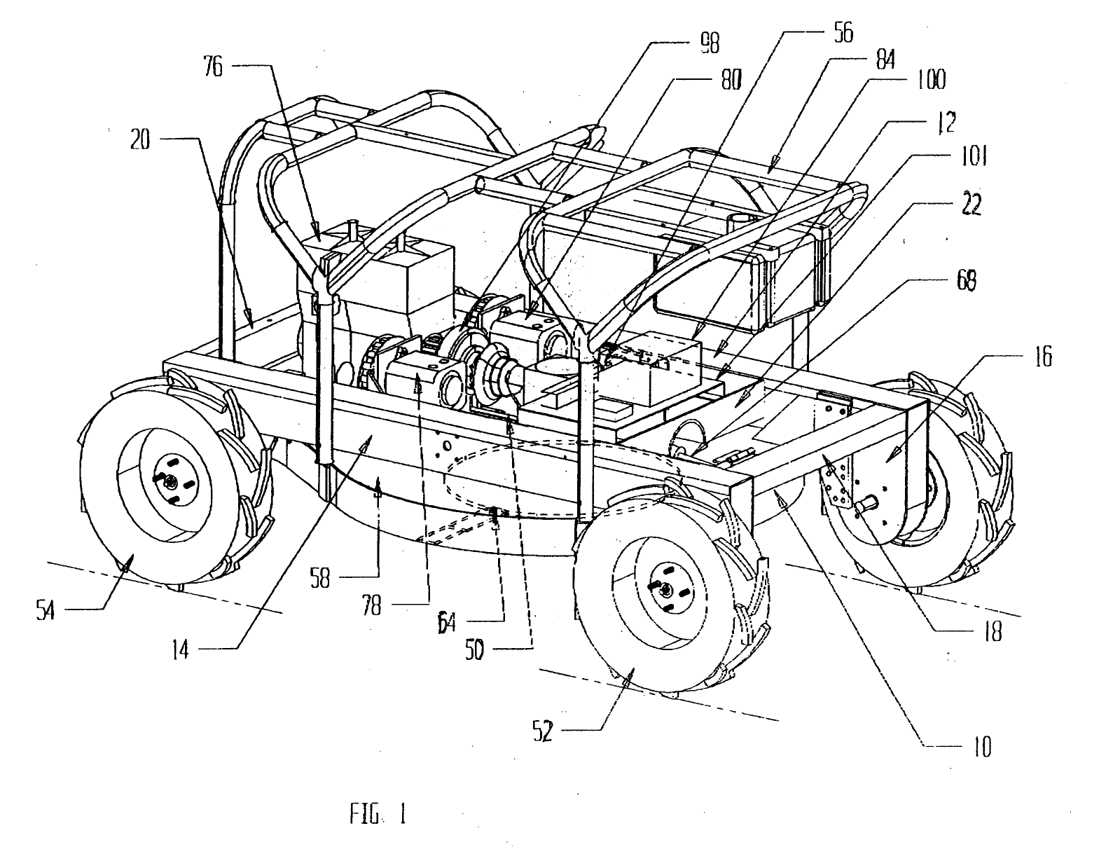

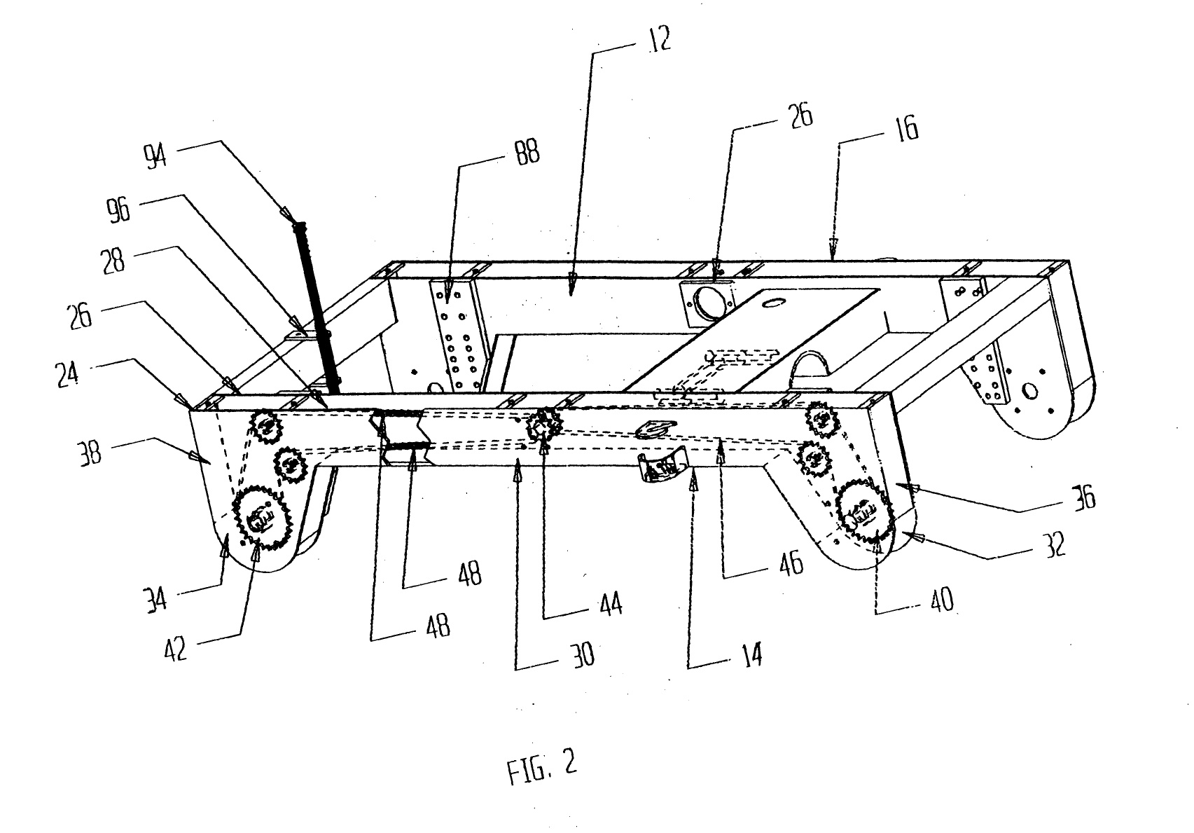

Referring to the drawings, FIG. 1 shows a remotely controlled mower 10 which includes a frame 12 comprising a right frame member 14 and a left frame member 16 which are connected by front crossmember 18, rear crossmember 20 and hydraulic oil tank 22. As may be seen in more detail in FIG. 2, right frame member 14 is a hollow structure comprised of an outer plate 24, an inner plate 26, a top plate 28, a bottom plate 30, arc plates 32 and 34, a front end plate 36 and a rear end plate 38. Disposed within right frame member 14 are a front wheel drive sprocket 40, a rear wheel drive sprocket 42, motor sprockets 44, and drive chains 46 and 48, which respectively connect the drive sprockets 40 and 42 to the motor sprockets 44. Hydraulic motor 50 is mounted on inner plate 26 and connected to motor sprockets 44 so as to drive the right side ground wheels 52 and 54 shown in FIG. 1. The left frame member 16 is a mirror image of the right frame member 14 and houses similar sprockets and drive chains, which are driven by hydraulic motor 56.

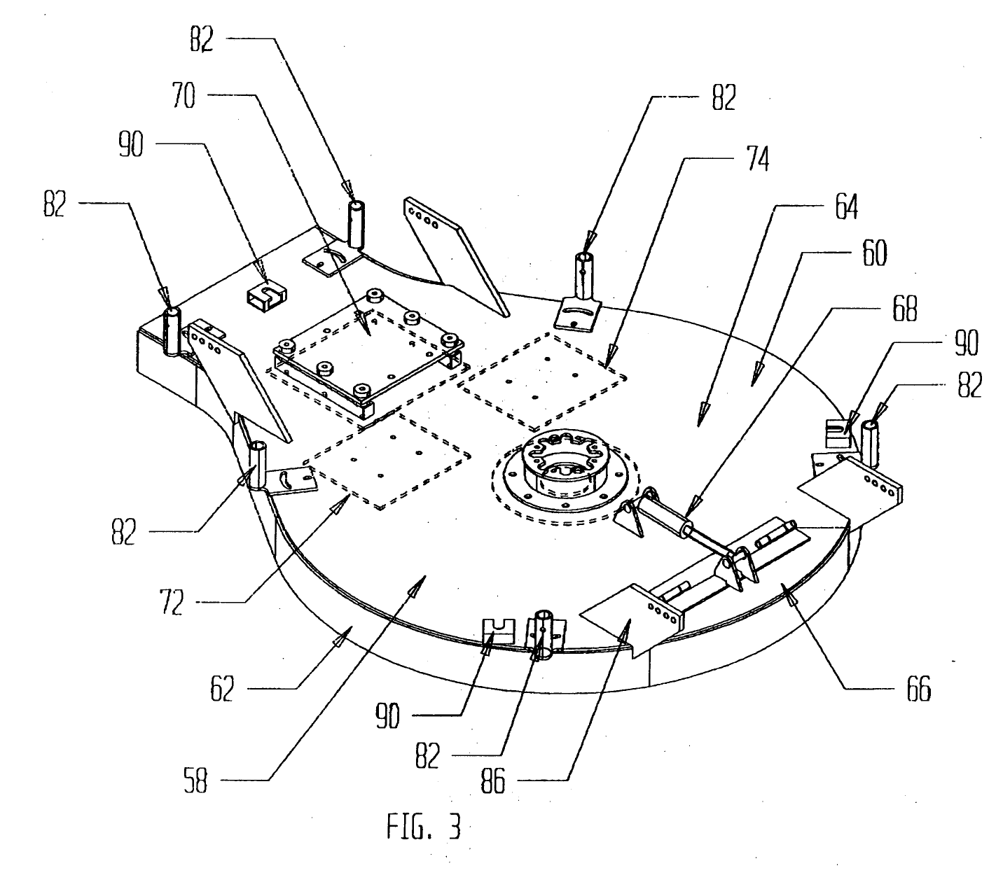

FIGS. 1 and 3 show a mower deck 58 comprising an upper plate 60 and side guard 62 to guard the vegetation cutting blade 64. The deck 58 includes a retractable segment 66, which can be raised and lowered by means of hydraulic cylinder 68. Support plates 70, 72 and 74 are provided for mounting an internal combustion engine 76, a right side hydraulic pump 50 and a left side hydraulic pump 80 respectively. Support pipes 82 are attached to the side guard 62 to allow rollover bars 84 to be removably affixed to the mower deck 58. The deck 58 is provided with attachment plates 86 and, as shown in FIG. 2, the frame 12 is provided with mounting plates 88 so that the deck 58 can be bolted to the frame 12. As is illustrated in FIG. 2, the mounting plates 88 have bolt holes at different heights so that the height of the deck with respect to the frame can be adjusted.

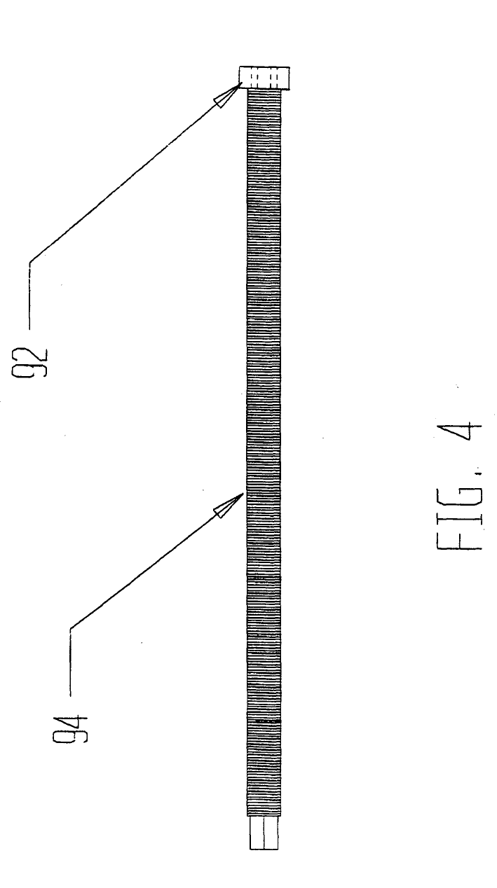

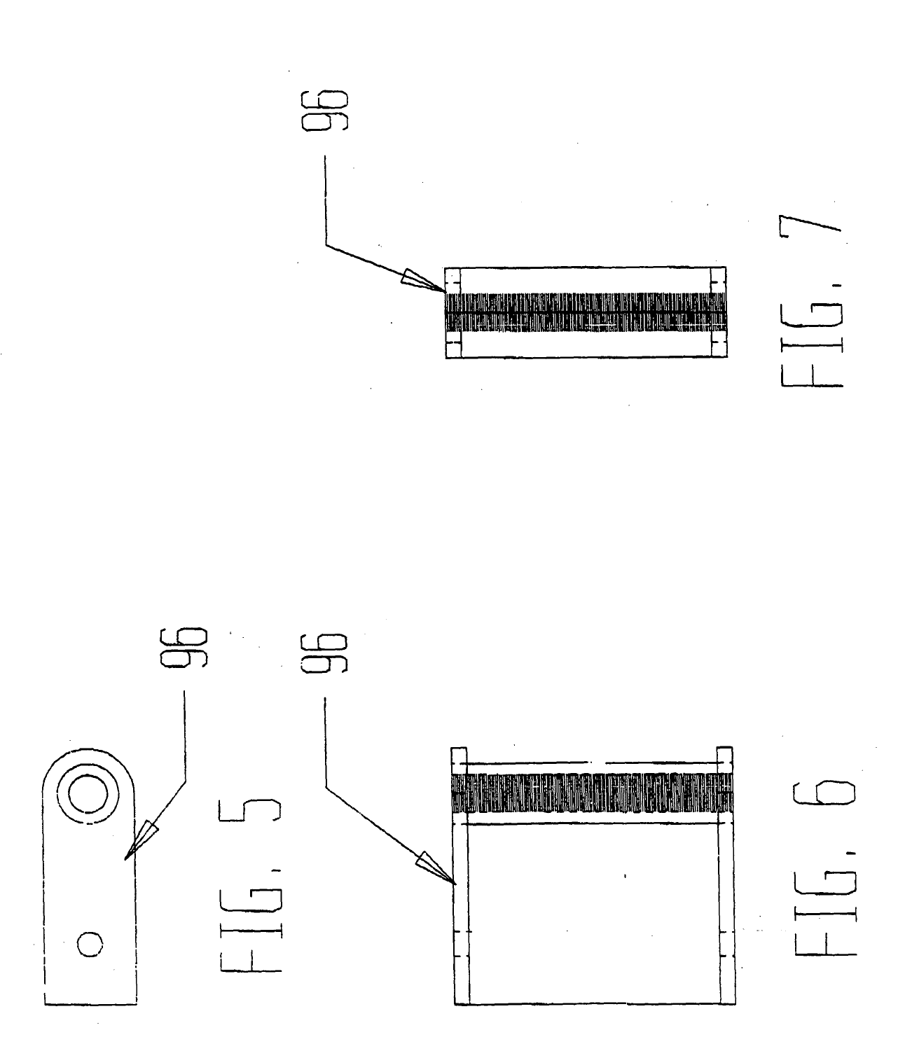

As shown in FIG. 3, the deck 58 is also provided with three lift tabs 90, each of which is slotted to accept the head 92 of a lifting screw 94, which is illustrated in FIG. 4. FIGS. 5, 6 and 7 show a bracket 96 for temporarily attaching a lifting screw 94 to the frame 12. In order to adjust the height of the deck 58, the heads 92 of lifting screws 94 are engaged to the slots of the three lift tabs 90 and the lifting screws 94 are attached to the frame 12 by means of lifting brackets 96. The attachment plates 86 on the deck 58 are then unbolted from the mounting plates 88 on the frame 12, after which the height of the deck may be adjusted by turning the lifting screws with a wrench. The attachment plates 86 are then rebolted to the mounting plates 88 and the lifting screws and lifting brackets are removed.

As is shown in FIG. 1, the internal combustion engine 76 drives the hydraulic pumps 78 and 80 and vegetation cutting blade 64 through conventional mechanical connections. A clutch 98 is provided so that the vegetation cutting blade 64 can be disengaged without depriving the hydraulic pumps 78 and 80 of power. The hydraulic pumps 78 and 80 are hydraulically connected to the hydraulic motors 14 and 16 respectively by flexible hoses, not shown, which permit each hydraulic pump to drive the hydraulic motor to which it is connected regardless of the adjustment of the height of the deck 58 with respect to the frame 12.

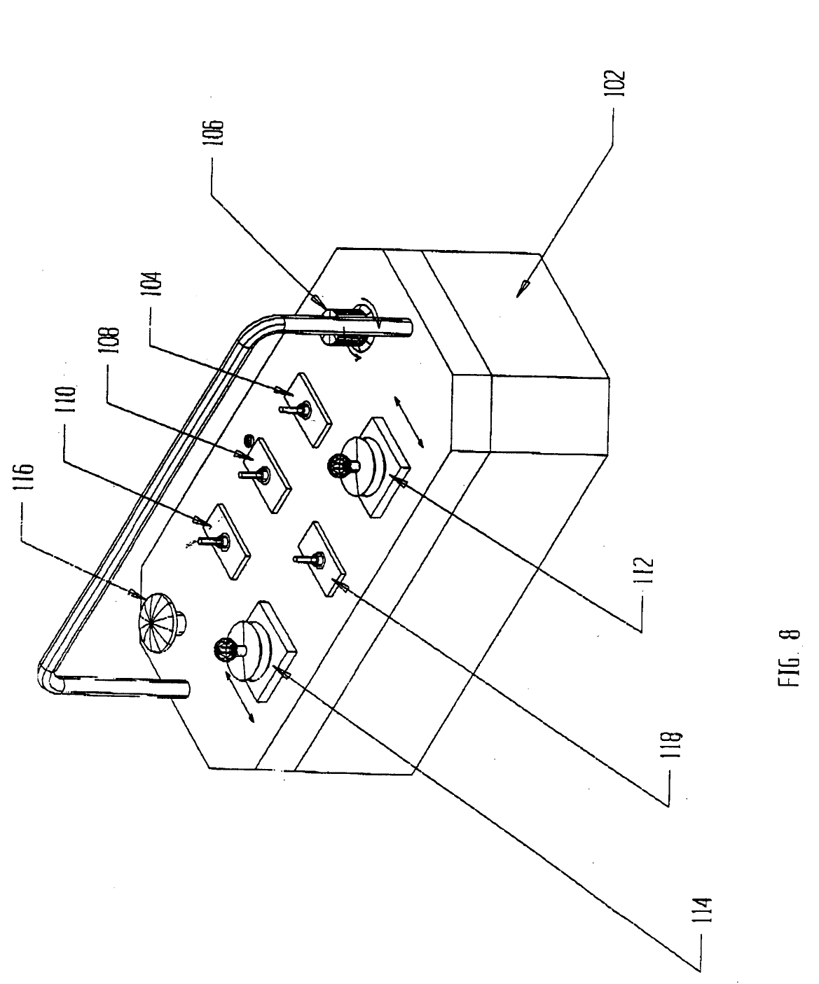

A radio remote control receiver 100 is attached to a bracket 101 attached to the hydraulic oil tank 22 to provide remote control of the engine 76, the right hydraulic pump 78, the left hydraulic pump 80, the clutch 98, and the hydraulic cylinder 68. By means of a radio remote control transmitter 102 as shown in FIG. 8, the engine 76 can thus be remotely started and stopped by a switch 104 and the engine rpm can be controlled by a rheostat 106. The vegetation cutting blade 64 can be remotely activated and deactivated by engaging or disengaging the clutch 98 by operating clutch switch 108. The retractable segment 66 of the deck 58 can be raised and lowered by remote activation of the hydraulic cylinder 68 by operating front deck switch 110. The speed and direction of rotation of the right side ground wheels 52 and 54 can be remotely controlled controlling right hydraulic pump 78 by operation of right joystick 112, while the speed and direction of rotation of the left side ground wheels can be independently controlled by remotely controlling left hydraulic pump 80 by operating left joystick 114. It will be understood that the mower 10 can thus be caused to move forward, backward, turn or pivot by appropriately manipulating the joysticks 112 and 114. The remote control transmitter 102 is also provided with an emergency stop button 116 whose activation will stop the engine 76, disengage the clutch 98 and activate brakes, not shown, on the four ground wheels and on the vegetation cutting blade 64. The remote control transmitter 102 is turned off and on by operation of switch 118.

I have found it desirable to utilize as the internal combustion engine 76 referred to above a commercially available two cycle gasoline engine capable of generating approximately 50 horsepower at 4500 rpm.

Many changes and modifications in the above described embodiment of my invention can, of course, be carried out without departing from the scope thereof.

1. A mowing device comprising;
a frame having a right side and a left side,
a first pair of ground wheels mounted on said right side of said frame,
a second pair of ground wheels mounted on said left side of said frame,
means for remotely controlling the speed and direction of rotation of said first pair of ground wheels,
means for remotely controlling the speed and direction of rotation of said second pair of ground wheels independent of the speed and direction of rotation of said first pair of
ground wheels,
a deck vertically adjustably attached to said frame, and
a vegetation cutting blade rotatably attached to said deck.

2. A mowing device according to claim 1 wherein said means for remotely controlling the speed and direction of rotation of said first pair of ground wheel comprises a first remotely controllable motor mounted on said right side of said frame and said means for controlling the speed and direction of rotation of said second pair of ground wheels comprises a second remotely controlled motor mounted on said left side of said frame.

3. A mowing device according to claim 2 wherein said deck includes a retractable segment and remotely controlled means for raising and lowering said retractable segment.

4. A mowing device according to claim 2 further comprising;
a remotely controlled internal combustion engine mounted on said deck, and
a remotely controlled clutch connecting said remotely controlled internal combustion engine to said vegetation cutting blade.

5. A mowing device according to claim 4 wherein said internal combustion engine is a two cycle gasoline engine.

6. A mowing device according to claim 5 further comprising a plurality of rollover bars attached to said deck.

7. A mowing device comprising;
a frame having a right side and a left side,
a deck detachably attachable to said frame at any one of a plurality of heights,
a vegetation cutting blade rotatably attached to said deck,
a first pair of ground wheels mounted on said right side of said frame,
a second pair of ground wheels mounted on said left side of said frame,
a first remotely controlled hydraulic pump mounted on said deck,
a first hydraulic motor mounted on said right side of said frame, said first hydraulic motor being hydraulically connected to said first remotely controlled hydraulic pump and said first hydraulic motor being mechanically connected to said first pair of ground wheels,
a second hydraulic pump mounted on said deck, said second hydraulic pump being remotely controllable independent from said first hydraulic pump, and
a second hydraulic motor mounted on said left side of said frame, said second hydraulic motor being hydraulically connected to said second remotely controlled hydraulic pump and said second hydraulic motor being mechanically connected to said second pair of ground wheels.

8. A mowing device according to claim 7 wherein said deck includes a retractable segment and remotely controlled means for raising and lowering said retractable segment.

9. A mowing device according to. claim 7 further comprising;
a remotely controlled internal combustion engine mounted on said deck and
a remotely controlled clutch connecting said remotely controlled internal combustion engine to said vegetation cutting blade.

10. A mowing device according to claim 9 wherein said internal combustion engine is a two cycle gasoline engine.
